(19) United States
(12) Patent Application Publication
(10) Pub. No.: US 2003/0005350 A1
(43) Pub. Date: Jan. 2, 2003

(54) Failover management system

(76) Inventors: Maarten Koning, Bloomfield (CA); Tod Johnson, Campbell, CA (US); Yiming Zhang, Castro Valley, CA (US)

Correspondence Address: DAVIDSON, DAVIDSON & KAPPEL, LLC, 485 SEVENTH AVENUE, 14TH FLOOR, NEW YORK, NY, 10018, US

(21) Appl. No.: 09/896,959

(22) Filed: Jun. 29, 2001

(51) Int. Cl. H04L 1/22

(52) U.S. Cl. 714/4

(57) ABSTRACT

A system is provided which includes a plurality of nodes, wherein each node has a processor executable thereon. The system also includes a first failover server group that includes a first server that is capable of performing a first service and a second server capable of performing the first service. The first server is executable on a first node of the plurality of nodes and the second server is executable on a second node of the plurality of nodes. The third server is executable on the first node and the fourth server being executable on one of the plurality of nodes other than the first node. The system also includes a second failover server group that includes a third server capable of performing a second service and a fourth server capable of performing the second service. The first, second, third and fourth servers can each be in one of a plurality of states including an active state and a standby state. The system also includes a failover management system that, upon determining that a failure has occurred on the first node, instructs the second server to change its state to the active state if the first server was in the active state when the failure determination occurred, and instructs the fourth server to change its state to the active state if the third server was in the active state when the failure determination occurred.

### BACKGROUND

Computer networks are comprised of plural processors that interact with each other. Therefore, a failure of one processor in the network may impact the operation of other processors on the network which require the services of the failed processor. For this reason, it is known to provide redundancy in the network by providing back-up processors which will step in to provide the services of a failed processor.

Conventionally, failover systems are directed to a failover of a physical device, such as a computer board, with redundant computer boards provided, each having identical software executing thereon.

### SUMMARY OF THE INVENTION

In accordance with a first embodiment of the present invention, a system is provided which includes a plurality of nodes, wherein each node has a processor executable thereon. The system also includes a first server group, a second server group, and a failover management system. The first server group includes a first server that is capable of performing a first service and a second server capable of performing the first service. The first server is in one of a plurality of states including an active state and a standby state and the second server is in one of the active state and an inactive state. The first server is executable on a first node of the plurality of nodes and the second server is executable on a second node of the plurality of nodes.

The second server group includes a third server capable of performing a second service and a fourth server capable of performing the second service. The third server is in one of the plurality of states including the active state and the standby state and the fourth server is in one of the active state and an inactive state. The third server is executable on the first node and the fourth server is executable on one of the plurality of nodes other than the first node.

The failover management system, upon determining that a failure has occurred on the first node, instructs the second server to change its state to the active state if the first server was in the active state when the failure determination occurred, and instructs the fourth server to change its state to the active state if the third server was in the active state when the failure determination occurred.

In accordance with a second embodiment of the present invention, a system including a plurality of nodes, a first server group, and a second server group as described above with regard to the first embodiment. However, in accordance with the second embodiment, the failover management system, upon determining that a failure has occurred on the first server but not on the third server, instructs the second server to change its state to the active state if the first server was in the active state when the failure determination occurred and the fourth server remains in a standby state if the third server was in the active state when the failure determination occurred.

In accordance with a third embodiment of the present invention, a failover management process is provided which is executable on a node that includes a first server in a first server group and a second server in a second server group. The failover management process determines a current state of the first server and a current state of the second server. In this regard, the current state of each server is one of a plurality of states including an active state, a standby state, and a failed state. The process also monitors a current state of a third server on a remote node. The third server, in turn, is one of the servers in the first server group, and the current state of the third server is one of the plurality of states including the active state, the standby state, and the failed state. The process also monitors a current state of a fourth server on a remote node and the fourth server is one of the servers in the second server group. The current state of the fourth server is one of the plurality of states including the active state, the standby state, and the failed state. The process notifies a process on the remote node executing the third server and a process on the remote node executing the fourth server of changes in the current state of the first server and the second server. Moreover, if the current state of the first server is the standby state, and the current state of the third server is failed, the process changes the current status of the first server to the active state, and, if the current state of the second server is the standby state, and the current state of the fourth server is failed, the process changes the current state of the second server to the active state.

In accordance with a fourth embodiment of the present invention, a failover management system is provided which includes global failover controller, a first local failover controller, a second local failover controller, a first server group, and a second server group. The global failover controller is executable on a first node of a plurality of nodes, the first local failover controller is executable on the second node, and the second local failover controller is executable on the third node.

The first server group includes a first server capable of performing a first service and a second server capable of performing the first service. The first server is in one of a plurality of states including an active state and a standby state, and the second server is in one of the active state and an inactive state. The first server is executable on a second node of the plurality of nodes and the second server is executable on a third node of the plurality of nodes. The second server group includes a third server capable of performing a second service and a fourth server capable of performing the second service. The third server is in one of the plurality of states including the active state and the standby state, and the fourth server is in one of the active state and an inactive state. The third server is executable on the first node and the fourth server is executable on a node other than the second node and the third node (e.g., the first node, or a fourth node).

The first local failover controller notifies the global failover controller of a current state of the first server and the third server, and the second local failover controller notifies the global failover controller of a current state of the second server. The global failover controller, in turn, notifies the first local failover controller of the current state of the second server and the fourth server and notifies the second failover controller of a current state of the first server. The first local failover controller, upon receiving notification that the second server is in an inactive state, instructs the first server to change its state to the active state if the first server was in an inactive state when the notification was received, and the second local failover controller, upon receiving notification that the first server is in an inactive state, instructs the second server to change its state to the active state if the second server was in an inactive state when the notification was received. The first local failover controller, upon receiving notification that the fourth server is in an inactive state, instructs the third server to change its state to the active state if the third server was in an inactive state when the notification was received.

In accordance with a further embodiment of the present invention, the “node other than the second node and the third node” of the fourth embodiment is a fourth node, the fourth node has a third local failover controller executable thereon, and the third local failover controller notifies the global failover controller of a current state of the fourth server.

### BRIEF DESCRIPTION OF THE DRAWINGS

FIG. 1 illustrates a set of server groups on a plurality of nodes.

FIG. 2(a) illustrates an embodiment of a failover management system including a global failover controller and a plurality of local failover controllers.

FIG. 2(b) illustrates an embodiment of a failover management system including a primary global failover controller, a backup global failover controller and a plurality of local failover controllers.

FIG. 2(c) illustrates an embodiment of a failover management system including a primary FMS synchronization server, a backup FMS synchronization server, and a plurality of FMS clients.

FIG. 3 shows an illustrative state transition diagram for a server in accordance with an embodiment of the present invention.

FIGS. 4(a,b) show a state transition decision table for the diagram of FIG. 3.

FIGS. 5(a,b) illustrate hierarchical server groups and servers, respectively.

### DETAILED DESCRIPTION OF THE PREFERRED EMBODIMENTS

Various embodiments of a failover management system in accordance with the present invention will now be discussed in detail. Prior to addressing the details of these embodiments, it is appropriate to discuss the meaning of certain terms.

In the context of a a failover management system, a node is an instance of an operating system (such as V×Works®) running on a microprocessor and a server is an entity that provides a service. In this regard, a node can support zero, one or more servers simultaneously. It should be noted that a server is not necessarily a standalone piece of hardware but may also represent a software entity such as a name server or an ftp server. A single node can have many servers instantiated on it. A server is referred to as an active server when it is available to actively provide services. In contrast, a standby server is a server that is waiting for a certain active server to become unable to provide a service so that it can try to provide that service.

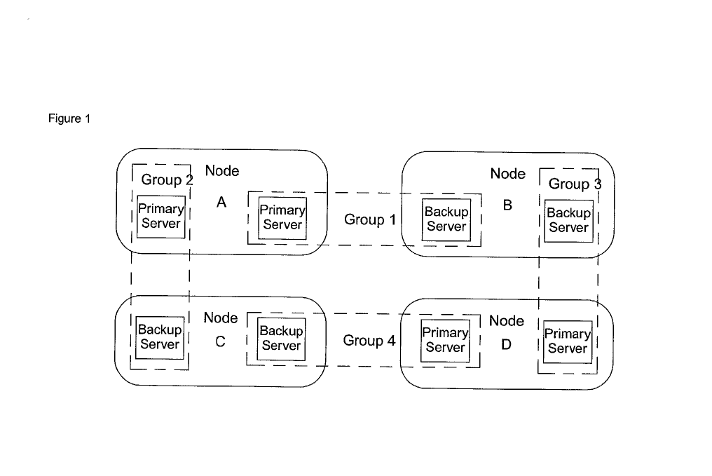

The term server group refers to a set of servers that can each provide the same service. The primary server is the server in a group of servers that normally becomes the active server of the server group, and the backup server is a server in a group of servers that normally becomes a standby server in the server group. Referring to FIG. 1, a system is shown which includes four nodes (A, B, C, and D) and four server groups (1, 2, 3, 4). In this illustration, server group 1 includes a primary server on node A and a backup server on node B, server group 2 includes a primary server on node A and a backup server on node C, server group 3 includes a primary server on node D and a backup server on node C, and server group 4 includes a primary server on node D and a backup server on node C.

The term failover refers to an event wherein the active server deactivates and the standby server must activate. Generally, the term failover is used in relation to a service provider. A cooperative failover is a failover wherein the active server notifies the standby server that it is no longer active and the standby server then takes over the active server role. A preemptive failover (or forced takeover) is a failover wherein the standby server detects that the active server is no longer active and unilaterally takes over the active serve role. Referring again to FIG. 1, if Node A were to fail, then the group 2 backup server on node C and the group 1 backup server on node B would both become active. It should be noted, however, that it is possible for a server on a node to fail, while the node itself remains active. For example, if the group 1 primary server were to fail while node A remained active, then the group 1 backup server on node B would become active, but the group 2 backup server on node C would remain in a standby state. Although FIG. 1 illustrates a system with only four nodes, with two servers on each node, it should be appreciated that the system and method in accordance with the present invention can support any number of nodes, each having any number of servers executing thereon.

The term switchover refers to an event where a failover occurs and clients of a service must start using the standby server once it activates. Generally, this term is used in relation to a service consumer. Referring to FIG. 1, if server group 3 is a client of server group 2 and node A fails, then the primary server of server group 3 would “switchover” from the primary server of server group 2 to the backup server of server group 2. After the switchover, if server group 3 requires services from server group 2, it will request those services from the backup server of server group 2.

A 1+1 sparing refers to a server group containing two servers where a primary server provides service and a backup server is ready to provide that service should the primary server fail. Active/Active refers to a 1+1 sparing configuration where both the primary and the backup servers provide a service simultaneously but should the primary fail then its clients switchover to the backup server. Similarly, Active/Standby refers to a 1+1 sparing configuration where the primary server provides services and the backup server only provides services when the primary server fails. The term Split Brain Syndrome refers to a 1+1 active/standby sparing configuration where both servers believe they should be active resulting in an erroneous condition where two servers are simultaneously active.

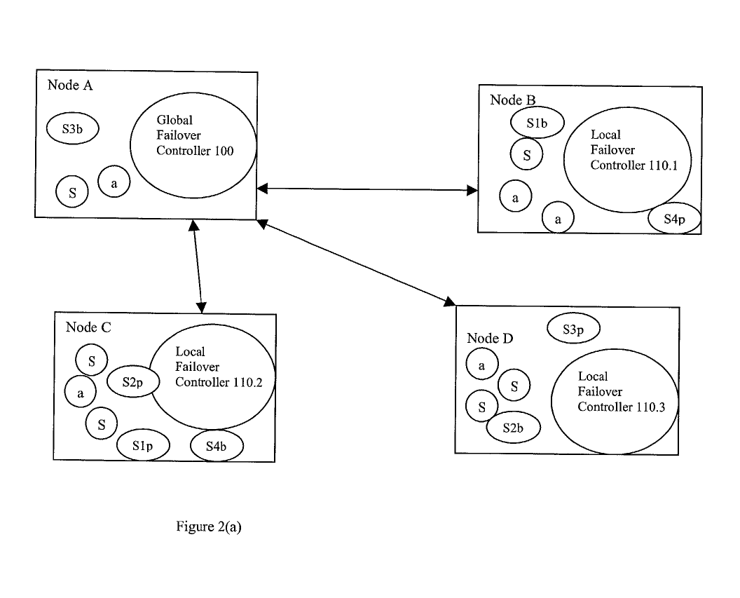

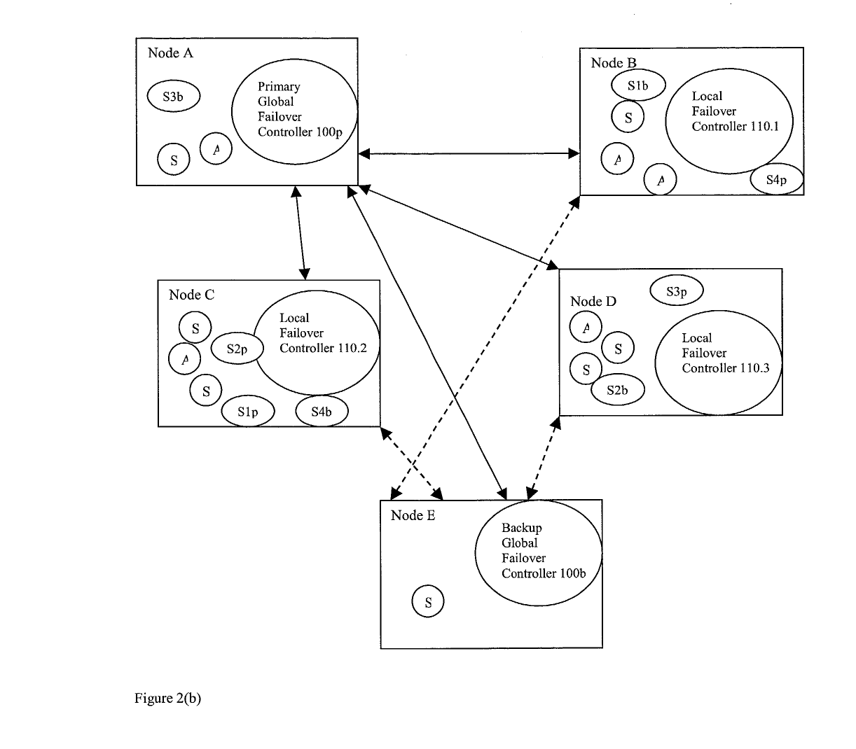

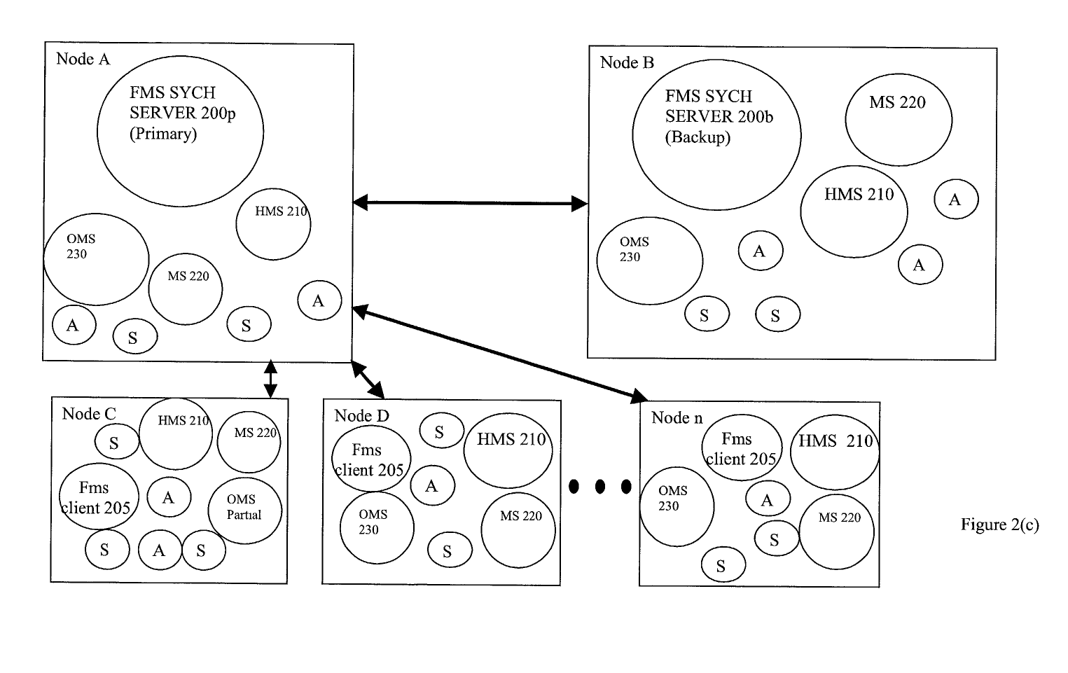

FIG. 2(a) illustrates an exemplary system implementing an embodiment of the present invention which includes a plurality of nodes (nodes A through D). The system also includes a first server group which includes a primary server S1p on node C and a backup server S1b on node B, a second server group which includes a primary server S2p on node C and a backup server S2b on node D, a third server group which includes a primary server S3p on node D and a backup server S3b on node A, and a fourth server group which includes a primary server S4p on node B and a backup server S4b on node C. In addition, each node may have servers (S) executing thereon which are not part of any server group, and may have application programs (a) executing thereon. The servers (s) and applications (a) may utilize the services provided by the various servers in the server groups.

Each of the servers S1p, S1b, S2p, S2b, S3p, S3b, S4p, and S4b can be in one of a plurality of states which include an active state in which the server is available to render services and an inactive state in which it is not available to render services. Most preferably, the inactive state can be one of a standby state, a failed state, an unknown state, an offline state, and an initialized state. Each of the nodes A through D can also be in one of a plurality of states which include an active state and an inactive state, and most preferably, the inactive state can be one of a failed state, an unknown state, an offline state, and an initialized state. Each of the four server groups can also be in one of a plurality of states which include an active state and an inactive state, and most preferably, the inactive state is an offline state. Preferably, a server group is in the active state when at least one of its servers is in either the active state or the standby state.

The system of FIG. 2(a) also includes a global failover controller 100 executing on Node A, and respective local failover controllers 110.1 through 110.3 executing on nodes B, C, and D. Each of the local failover controllers determines the state of its local node and each server executing on the local node that forms part of a server group, and transmits any state changes to the global failover controller 100. For example, the local failover controller 110.1 monitors the state of its local node B and servers S1b and S4p and transmits any state changes for node B, server S1b, or server S4p to the global failover controller 100.

The global failover controller 100 also determines the state of its local node and each server executing on the local node that forms a part of a server group. However, since each local failover controller transmits its local state changes to the global failover controller, the global failover controller is able to monitor the state of each of nodes A, B, C, D, and of servers S1p, S1b, S2p, S2b, S3p, S3b, S4p, and S4b.

The global failover controller 100 transmits any state changes in these nodes, servers, or server groups to the local failover controllers 110.1 through 110.3. Each local failover controller uses this information to monitor the states of remote nodes and servers that are of interest to the processes executing on its local node. For example, if none of the servers or applications on node B interact with the servers in the second server group, the local failover controller 110.1 need not monitor the state of servers s2p and s2b, or of the second server group. In contrast, the local failover controller 110.1 will monitor the states of node C, servers S1p and S4b, and server groups one and four because the servers on Node B (S1b and S4p) need to interact with those servers and server groups on node D in the event of failover.

The state of each of the four server groups is derived from the states of its individual servers. For example, if the global failover controller determines that at least one of the servers in a server group is active, then it could set the status of that server group to Active. Preferably, the global failover controller transmits server states, but not server group states, to the local failover controllers, and the local failover controllers derive any server group states of interest from the states of the servers which form the groups. Alternatively, the global failover controller could transmit the server group states to the local failover controllers along with the server states. It should also be understood that the server group states could be eliminated from the system entirely, and failover and switchover could be managed based upon the server states alone.

Preferably, each local failover controller 110.1-110.3 periodically sends its local state information (as described above) to the global failover controller 100, and the global failover controller 100 transmits its global state information in response thereto. In this regard, the transmission by the local failover controller may include the current state for its local node and all servers in server groups on its local node, or may only include state information for a given local node or server when the state of that node or server has changed. Similarly, the transmission by the global failover controller may include current state for each node, each server in a server group, and each server group, or may only include state information for a node, server group, or server when the state of that node, server group, or server has changed. In this regard, if there are no state changes, a global failover controller or local failover controller may simply transmit “liveliness” information indicating that the controller transmitting the information is alive.

In any event, through this state determination, transmission, and monitoring protocol, the global failover controller 100 can efficiently coordinate failover of the servers in the server groups. For example, upon receiving notification from local failover controller 100.1 that the state of server s4p has changed from active to failed, the global failover controller 100 will propagate this state change to all the local failover controllers by indicating that the state of server s4p has changed to failed.

Upon receiving this information, local failover controller 110.2 will instruct server s4b to become active. In addition, the local failover controller 110.2 will notify any interested server or applications on node C that server S4p has failed. Any other local failover controllers that are monitoring state change in server S4p will similarly notify any interested server or applications on their respective local nodes that server S4p has failed.

Once server s4b has become active, the local failover controller 110.2 will notify the global failover controller 100 of this state change. The global failover controller 100 will then notify the local failover controllers that the state of server s4b is active. The local failover controllers monitoring the state of server s4b will, in turn, notify any interested servers or applications on their respective nodes that server s4b is now the active server in server group 4. With this information, these interested servers and applications (a) will interact with server s4b in order to obtain services from server group four.

As another example, let us assume that global failover controller 100 has not received any state change communications from Node C for an unacceptable period of time. The global failover controller 100 will then change the state of Node C and of servers sip, s2b and s4b to an inactive state (e.g., unknown), and transmit this state change information to the local failover controllers 110.1-110.3. If local failover controller 110.2 is able to receive this information, it can take appropriate action, such as rebooting the node and all the servers on the node. In any event, local failover controller 110.1 will instruct server sib to become active and local failover controller 110.3 will instruct server s2b to become active. In addition, the local failover controllers 110.1 and 110.3 will notify any interested local server or applications on their respective nodes of the state changes.

As failover server s1b and s2b become active, their corresponding local failover controllers 110.1 and 110.3 will notify the global failover controller 100 of this state change. The global failover controller 100 will then notify the local failover controllers that the states of server s1b and s2b are active. Any interested local failover controllers will, in turn, notify any interested servers or applications on their respective nodes of these changes. With this information, these interested servers and applications (a) will interact with server sib and s2b in order to obtain services from server groups one and two respectively.

FIG. 2(b) shows a further embodiment of the present invention which includes a primary global failover controller 100p and a backup global failover controller 100b. In this embodiment, the primary global failover controller 100p and the backup global failover controller 100b can be in one of an active state and an inactive state. Preferably, the inactive state can be one of a standby state, a failed state, an unknown state, an offline state, and an initialized state. This system operates in a similar manner to the system of FIG. 2(a), except that if the global failover controller 100p becomes inactive, the global failover controller 100b becomes active, and the local failover controllers send state information to, and receive state change information from, the global failover controller 100b rather than the global failover controller 100p (as indicated by the dashed lines in FIG. 2(b)).

In this embodiment, the global failover controllers 100p and 100b, and the local failover controllers 110.1, 110.2, 110.3 each monitor the state of the global failover controllers 100p and 100b. In this regard, when the global failover controller 100p is in the active state and the global failover controller 100b is in the standby state, the global failover controller 100b periodically transmits its local state changes to the global failover controller 100p, and the global failover controller 100p periodically transmits all state changes in the system (including its own state changes and state changes to the global failover controller 100b) to the global failover controller 100b, and to the local failover controllers. Since the global failover controller 100b must be able to provide systemwide state change information to the local controllers when it is in the active state, it monitors the states of all nodes, servers, and server groups via its communication with the global failover controller 100p.

Assume, for example, that the global failover controller 100p for some reason changes its state to offline. This state change will be transmitted by the global failover controller 100p to the local failover controllers and the global failover controller 100b. Upon receiving this notification, the global failover controller 100b will change its state to active and will begin providing notification of all state changes in the system to the local failover controllers. The transition to the global failover controller 100b can be implemented in a variety of ways. For example, upon becoming active, the global failover controller 100b may automatically transmit system wide state change information (with the state of the global failover controller 100b set to active) to all of the local failover controllers, thereby informing the local failover controllers that future state change transmissions should be sent to the global failover controller 100b. Alternatively, upon receiving notification of the inactive state of the global failover controller 100p, the local controllers may simply begin transmitting their local state information to the global failover controller 100b and await a reply.

As another example, let us assume that global failover controller 100b has not received any state change communications from global failover controller 100p for an unacceptable period of time. The global failover controller 100b will then change the state of Node A, S3b, and global failover controller 100p to an inactive state (e.g., unknown), and transmit this state change information to the local failover controllers and to the global failover controller 100p. If global failover controller 100p is able to receive this information, it can take appropriate action, such as rebooting the node and all the servers on the node. In any event, the transition to the global failover controller 100b can be implemented in a variety of ways as described above.

FIG. 2(c) illustrates the components of a failover management system in accordance with a preferred embodiment of the present invention. A network is composed of “n” nodes, and each node has executing thereon zero or more application servers (S), zero or more application programs (A), a messaging system (MS 220), and a heartbeat management system (HMS 210). In addition, Node A includes an primary FMS synch server 200p, Node B includes a backup FMS synch server 200b, and Nodes C-n include FMS clients 205. In the discussion that follows, FMS synch servers 200 and FMS clients 205 will be generically referred to as an FMS, and the term “local” will be used to refer to a component on the same node (e.g., the “local” FMS on Node A is the primary FMS synch server 200p), and the term “remote” will be used to refer to a component on another node (e.g., the primary FMS synch server 200p receives state change information from the remote FMSs on Nodes B-n).

In general, the primary FMS synch server 200p, HMS 210, and MS 220 of node A collectively perform the functions described above with respect to the primary global failover controller 100p, the backup FMS synch server 200b, HMS 210, and MS 220 of node B collectively perform the functions described above with respect to the backup global failover controller 100b, and the FMS client 205, HMS 210, and MS 220 of each of nodes C-n collectively perform the functions described above with respect to the local failover controllers 110.1-110.3.

In the embodiment of FIG. 2(c), the FMS primary synch server and the FMS backup synch server form a server group in a 1+1 Active/Standby sparing configuration, such that only one the servers is active at any given time. The active FMS synch server is the central authority responsible for coordinating failover and switchover of the application servers (S). The FMS clients communicate with the active FMS synch server in order to implement failovers and switchovers at the instruction of the active synch server. At least some of the application servers (S) are also arranged in server groups.

The active FMS synch server monitors the state of each application server (S) and each node to be controlled via the failover management system, and maintains a database of information regarding the state of the application servers and nodes, and the server group (if any) of which each application server forms a part. The “standby” FMS synch server maintains a database having the same information. FMS clients also maintain a database of information regarding the state of servers and nodes within the system. However, each FMS client need only maintain information regarding nodes and application servers of interest to its local node.

The term FMS State Entity (FSE) will be used herein to generically refer to nodes, servers or server groups for which an FMS maintains state information. The term “monitor”, as used herein, refers to an application function, specific to an FSE, that is invoked by an FMS when it detects a state change in that FSE. The state change of the FSE is then reported to the application (A) via the monitor.

A server or node can be in any one of the following states: initialize, active, offline, failed, and unknown. In addition, a server can be in a standby state if it forms part of a server group. A server group can be in any one of an active state and an offline state. In the discussion that follows, these states will be generically referred to as FSE states.

The state information used by the FMS synch servers and the FMS clients is preferably maintained in an object management system (OMS 230) residing on each node. The OMS 230 provides a hierarchical object tree that includes managed objects for each node, server, server group, and monitor known to the node. As an example, a server group can be instantiated by creating a managed object within an /oms/fins tree in OMS (with /oms/fms/ being the root directory of the tree). Servers are placed into the server group by creating child objects of that initially created managed object. As an example, one could create two network servers in a server group by creating the following managed objects:

/oms/fins/groups/net—the server group.

/oms/fms/groups/net/stack1—one network server in the server group.

/oms/fms/groups/net/stack2—a second network server in the server group.

Each node or server has a node object or server object instantiated in the OMS on that node that reflects the state of that node or server. It is the responsibility of the node or server software itself to maintain the state variable of that node or server object as the node or server changes state. Calls into the local FMS are inserted into the initialization and termination code of the system software to maintain this state variable.

If a node has knowledge of remote nodes, server groups and servers in the system, it will have additional node, server group, and server objects instantiated in its OMS to represent these other nodes, server groups, and servers. As set forth above, the nodes having an FMS synch server will include objects corresponding to each node, server group, and server in the system, whereas nodes having FMS clients may have a subset of this information.

An FMS client 205 performs a number of duties in order to facilitate server failover. Specifically, it determines the states of its local node and servers; reports the local node or servers state to the active FMS synch server; and via its monitors, notifies interested local servers and applications of node or server state changes of which it is aware.

In this regard, the OMS 230 on a node executing the FMS client 205 contains FSE objects for that node, all servers on that node, all monitors on that node, and for any remote nodes, remote servers, and server groups that are of interest to the FMS client 205. A remote node, remote server, or server group would be of interest to an FMS client 205, for example, if the servers and applications on its node need to interact with the remote node, server, or server group.

Propagation of state change information among nodes is performed by the FMSs via their respective HMSs. As described in more detail below, each FMS client, via its local HMS, notifies the active FMS synch server of any state changes in the node or its local servers. Via its local HMS, the active FMS synch server notifies each FMS client and the standby FMS synch server of any state changes in any node or server represented in the OMS of the active FMS synch server's node. Preferably, the HMS on the active FMS synch server transmits this information to a remote node in response to the receipt of state change information from that remote node.

Therefore, through the HMS 210, the FMS client 205 receives notification of all state changes for remote nodes and remote servers that are of interest to the FMS client, and maintains this information in its local OMS 230. With this information, the FMS client 205 can notify interested local servers and applications via its monitors when it learns of a remote node or server state change.

In order to facilitate server failover, an active FMS synch server also determines the states of its local node and servers and notifies interested local servers and applications when it learns of a node or server state change as described above. However, since each FMS client reports its local node and server(s) state changes to the active FMS synch server, the OMS on the active FMS synch server's node contains FSE states for each FSE object in the FMS system. It should be noted that the standby FMS synch server also reports its local node and server(s) state changes to the active FMS synch server. The active FMS sync server notifies the standby FMS synch server and the FMS clients of all node and server state changes.

The standby FMS synch server monitors the active FMS synch server via its HMS and takes over as the active FMS synch server in the FMS synch server group if necessary. Finally, the FMS clients also monitor the active FMS synch server via HMS, and, if no response is received, sets the state of the active FMS synch server, its local node, and any other servers on that local node to unknown.

To summarize, on each node, the OMS holds a respective object to represent each FSE object of interest to the node, and that FSE object contains the state of the node object, server object or server group object. On each node, the local FMS (which can be a synch server 200 or a client 205) manages changes to the FSE state on its local OMS. However, with regard to the states of remote nodes and servers, the local FMS is notified of the state changes from a remote FMS. More specifically, the active FMS synch server is notified of state changes in remote nodes and servers via the various FMS clients, and the various FMS clients are notified of state changes in remote nodes by the active FMS synch server. Through this cooperative process between the FMS synch servers and the FMS clients, the system implements server failover.

As mentioned above, a software entity can register to receive notification when an FSE's state changes by creating a monitor object and associating it with the FSE object in the OMS residing on the node that is executing the software entity. In order to register for FSE state changes, a software entity (which may be a server, server group, or any software entity on a node) creates a monitor object on its local node. The FMS on the local node associates the monitor object with the FSE that it monitors. When the FSE object that is being monitored changes state, each associated monitor object is notified of that by the FMS on the local node. The software entity that created the monitor object provides a method (e.g., a function call) which the FMS invokes whenever the FSE being monitored changes state. The method is notified of the FSE idenitifer, the current state, and the state being changed to. In this regard, whenever a server, server group, node (or other monitored object) changes state, the FMS on each node that is notified of this change goes through its list of monitors for that changed object, and executes each monitor (callback) routine. Preferably, it executes each monitor routine twice: once before the FMS implements the state transition on its local OMS (a “prepare event” such as prepare standby) and once afterwards (an “enter event” such as enter standby). Using this monitoring system, any software entity using a monitored object is notified of its state changes without requiring any inter-processor communication by the software entity itself.

If more that one monitor object is created for the same FSE they are preferably invoked in a predetermined manner. For example, they can be invoked one-at-a-time in alphabetical order according to the monitor name specified when the monitor was created. This mechanism can also be used to implement an ordered activation or shutdown of a node. One such scheme could prefix the names with a two digit character number that would order the monitors. Preferably, however, alphabetical ordering is not used when the state change is to the offline, failed, or unknown states. In such a case, the ordering is reverse alphabetic so that subsystems can manage the order of their deactivation to be the reverse of the order of their activation, which is usually what is desired in a system. In other words, if the system invokes the monitors alphabetically when moving from initialized to active or standby, it would generally wish to invoke the monitors in the opposite order when moving from standby or active to offline. In addition to the user of montioring routines, an application or server on a node can use APIs to query the state of any FSE represented on its local OMS.

### Failover

Failover procedures for the preferred embodiment of FIG. 2(c) will now be discussed in further detail. In order for failover to occur, one of the servers must be in an active state and the other must be in an standby state. Failover can be cooperative or preemptive. Cooperative failover occurs when the active server converses with the standby server in order to notify it of its transition to one of the disabled states before the standby server activates. This synchronized failover capability can be used, for example, to hand over shared resources (such as an IP address) from one server to another during the failover. Preemptive failover occurs when the active server crashs or becomes unresponsive and the standby server unilaterally takes over the active role. For the purposes of discussion in the following lists of sequential events that occur during failover, we label the initially active server “primary server” and the initially standby server “backup server”.

An exemplary event sequence that would occur during a cooperative server failover, beginning with the primary server's transmission of its state change information, is as follows:

1. primary server node's FMS notifies the other nodes' FMS that of the primary server's new state (offline or failed). If the primary server node's FMS is an FMS client, this notification is propogated to other FMS clients via the active FMS synch server.

2. in parallel, the other nodes' FMSs sequentially trigger the primary server's monitors due to the state change (e.g., “prepare” failed).

3. in parallel, the other nodes' FMSs update the primary server's FSE state.

4. in parallel, the other nodes' FMSs sequentially trigger the primary server's monitors due to the state change (e.g. to “enter” failed).

5. backup server node's FMS sequentially triggers the backup server's monitors due to a state change. In other words, the backup server node's FMS triggers the monitors on the backup server (i.e. monitors invoked by other software entities which monitor the backup server) and in this case the state change is from the current state of the backup server (usually standby) to “prepare” active.

6. backup server sets its state to active.

7. backup server node's FMS sequentially triggers the backup server's monitors due to another state change. However, in this case, the change is to “enter” active.

8. backup server node's FMS notifies other nodes FMSs that it is now active. Again, if the backup server node's FMS is an FMS client, this notification is propogated through the active FMS synch server.

9. in parallel, the other nodes' FMSs trigger the backup server's monitor for a prepare active event due to the state change.

10. in parallel, the other nodes' FMS set the backup server FSE state to active.

11. in parallel, the other nodes' FMSs sequentially trigger the backup server's monitors for an enter active event due to the state change.

It should be noted that although the above sequence is explained with reference to steps 1-11, this it not meant to imply that the one step must be completed before the next step begins. For example, when an FMS notifies another node of a state change, this notification process may occur in parallel with the the FMS triggering its monitors to for an “enter” event. Thus steps 7 and 8 may occur in parallel. Similarly, step 1 may occur in parallel with the primary server triggering its monitors for an “enter” failed or “enter offline” event. In the interest of clarity, the above sequence has illustrated beginning with the notification step (step 1), and has omitted this monitor triggering step.

An exemplary event sequence that would occur during an preemptive failover is as follows:

1. backup server detects that the primary server has failed.

2. backup server node's FMS sequentially triggers the primary server's monitors due to the state change (e.g. “prepare” failed).

3. backup server sets the primary server FSE state to failed.

4. backup server node's FMS sequentially triggers the primary server's monitors due to the state change. (If supported by the hardware, the backup server can attempt to reset the primary server's node over the backplane. For example, in the case of a PCI bus, a server on a CP (but not on a FP) can reset nodes over the backplane of the bus).

5. backup server's FMS notifies the other nodes FMSs to set the primary server FSE state to failed. If the backup server node's FMS is an FMS client, this notification is propagated to other FMS clients via the active FMS synch server.

6. in parallel, the other nodes' FMSs sequentially trigger the primary server's monitors for a prepare failed event.

5. in parallel, the other nodes FMSs set the primary server FSE state to failed.

6. in parallel, the other nodes sequentially trigger the primary server's monitors for an enter failed event.

(At this point, the backup server begins to activate).

7. backup server node's FMS notifies other nodes FMSs that it is now active.

8. in parallel, the other nodes' FMSs sequentially trigger the primary server's monitors for a prepare active event.

9. in parallel, the other nodes' FMSs set the backup server FSE state to active.

10. in parallel, the other nodes' FMSs sequentially trigger the backup server's monitors for an enter active event.

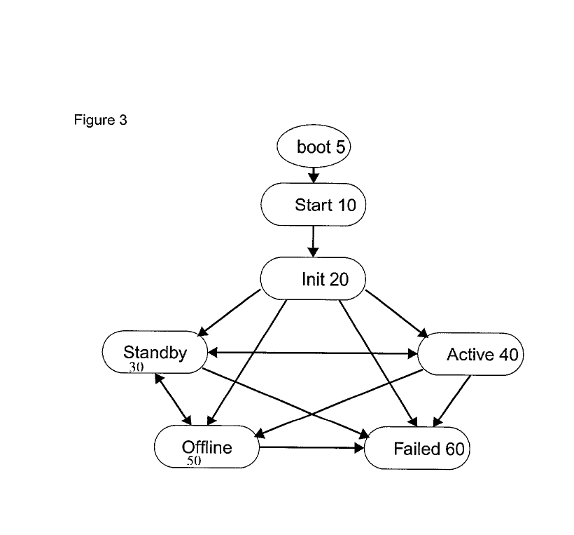

The state transitions that are preferably implemented via the system of FIG. 2(c) will now be described in detail. FIG. 3 illustrates the state transitions for the six states that a server normally traverses during its lifetime:

1. start 10—server has not initialized yet

2. init 20—server has initialized but has not decided if it should be the active or standby server

3. standby 30—server is waiting to provide service

4. active 40—server is the providing service

5. offline 50—server is not a candidate to provide service

6. failed 60—server has failed and cannot provide service.

In addition, a server can be in an “unknown” state if its state cannot be determined by the FMS.

Each member of a server group (e.g. primary and standby servers) monitors the other in order to collaborate to provide a service. This is done by considering a server's local state and the most recently known remote server's state together in order to make a decision on whether a state transition is required, and, if a state transition is required, to make a decision regarding the nature of the transition. This decision process begins once a server has reached the init state.

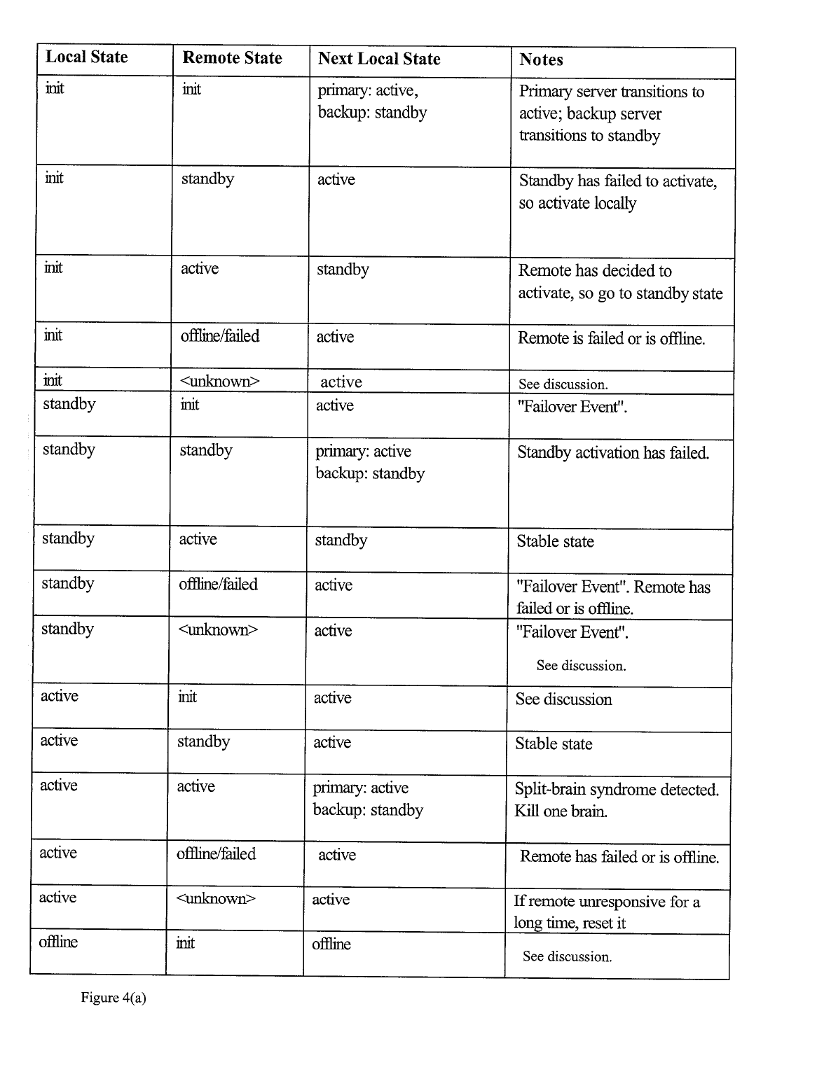

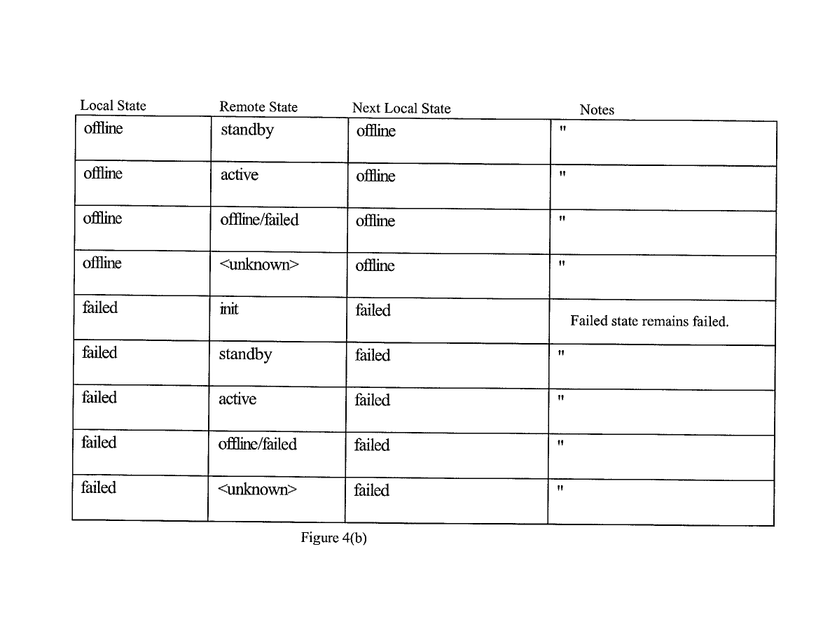

An exemplary decision matrix for the six states of FIG. 3 is shown in FIGS. 4(a,b). In the context of FIG. 4(a,b), the “local” state is the state of the node that the FMS resides on, and the “remote” state is the state of the other node in the server group that the FMS is monitoring. The matrix of FIGS. 4(a,b) applies to server groups which include a primary server and a backup server in a 1+1 Active/Standby sparing configuration. It should be noted that if a server is not in a server group with at least two servers, then the server should not enter the standby state.

Referring to FIG. 4(a), if both the local and remote states are “init” then the primary server will transition to active and the backup server will transition to standby. However, if the local state is init and the remote state is standby, then the local server will transition to active regardless of whether the local server is the primary or backup server. Similarly, if the local state is init and the remote state is active, then the the local server will transition to standby regardless of whether the local server is the primary or backup server. If the local state is init or standby and the remote state is offline or failed, then the local server will transition to active because the remote server is failed or offline.

If the remote state is unknown (i.e., the remote server has been unresponsive for a predetermined period of time), then the local server will consider the remote server failed and will generally transition to active if the local server is in the standby or init states, and remain in the active state if it is currently active. However, in this situation, there is a possibility that transitioning the local server to the active state will cause split brain syndrome (e.g., if the remote server is in fact active, but non-responsive). This can be dealt with in a number of ways. For example, the remote server can be instructed to reboot. Alternatively, the system could first try to determine the state of the remote server. The next local state would then be governed by the determined state of the remote node.

If both the local and remote states are standby (i.e. no brain syndrome), then the local server transitions to active if it is the primary server. If both the local and remote states are active (i.e. split brain syndrome), then the local server transitions to standby if it is the backup server.

If an FMS on a local node determines that a remote server has been in the ‘unknown’ or ‘init’ states for a specified period of time (configurable by the developer or user), it resets the node that contains the remote server. If an FMS determines that one of its local servers has been in the ‘offline’ state for a specified period of time, it resets its local node. Preferably, failed servers remain failed and no attempt is made to automatically re-boot a remote failed server from the FMS. In this regard, a failed server is assumed to have entered the failed state intentionally, and therefore, an automatic reboot is not generally appropriate. However, an automatic node reboot (or other policy) for a remote failed server (or the node on which it resides) can alternatively be provided. In alternative embodiments of the present invention, the system may simply reset a server that has been in the ‘unknown’, ‘nit’, ‘failed’ or ‘offline’ states for a specified period of time, rather than resetting the entire node on which the server resides.

As described above, servers, server groups, and other software entities can be advised of FSE state changes by registering a monitor with an FMS that tracks the state of the FSE. It is generally advantageous for the monitor code to be able to take action both during a state transition and after a state transition has completed. For example, one software entity invoking a monitor may need to bind to a well-known TCP/IP port during the activation transition and a second software entity invoking a monitor may need to connect to that TCP/IP port once the activation has completed in order to use the first software entity. For this reason, FMS preferably invokes all the monitors with information that can be used by software to synchronize with the rest of the system. For example, during a standby to active state transition, it calls all the monitors once to indicate that the transition is in progress and calls the monitors again to indicate that the transition has completed. This is done by passing a separate parameter that indicates either “prepare” or “enter” to the monitors. It is up to each individual subsystem to decide what to do with the information. A number of schemes can be used to provide this information.

For example, the transitional parameters “prepare” and “enter” could be combined with the state change as a single parameter. For example, the FMS could provide the following notification information parameters to its monitors:

1. Prepare Initialized

2. Enter Initialized

3. Prepare Standby

4. Enter Standby

5. Prepare Active

6. Enter Active

7. Prepare Failed

8. Enter Failed

9. Prepare Offline

10. Enter Offline

11. Prepare unknown

12. Enter unknown

Preferably, the monitor is informed of the current state of the FSE as well as one of the above parameters. In an alternative scheme, the FMS could simply provide the monitor with three separate parameters: the current state of the FSE, the new state of the FSE, and either a prepare on enter event.

In any event, providing the current state, new state, and transition event information is useful since work items for a server that is in standby state and going to the active state may well be different than work items for a server that is initializing and going to the active state. For example, “prepare” transition events are often used for local approval of the transition whereas “enter” transition events are often used to enable or disable the software implementing a FMS server.

In certain embodiments of the present invention the state/event combinations described above can be individually implemented in monitors so that a particular monitor need only receive notification of events that it is interested in. In addition, group options can be provided. For example, a monitor can choose to be notified of all “enter events”, all “prepare events”, or both.

If a monitor routine attempts to notify its software entity of another FSE state change during a state change event, the second state change will be processed after all of the monitors are invoked with the current state change.

In certain preferred embodiments of the present invention, the following FMS messages are sent between FMSs using the HMS:

1. JOIN: this message is sent when a node wants to join a system. The response is yes/no/retry/not qualify. If yes, the FMS synch server will start to heartbeat the node. The reply also contains a bulk update of the states of the other FSEs in the system. In addition, the active synch server will send the state of the new node and its local servers to the other nodes in the system. Preferably, once a node has joined the system, it heartbeats the active FMS synch server but not any other node in the system. Only an active FMS synch server responds “yes” to a join message. FMS clients issue JOIN requests to all potential active FMS synch servers (configured) that they are interested in. If the response is “retry”, the requesting node will resend the JOIN request after a predetermined delay. If the response is “not qualify”, the requesting node becomes the active FMS synch server and accepts join requests from other nodes. Naturally, the “not qualify” response is only sent to an FMS synch server.

2. STATECHANGE: this message is used by an FMS on one node to tell another node's FMS that an FSE state has changed. This message needs no reply. Preferably, FMS clients send this message only to the active FMS synch server. The active FMS synch server sends this message to the FMS clients and to the standby FMS synch server, and the standby FMS synch server sends this message to the active FMS synch server.

3. TAKEOVER: this message can be sent by a standby server to the active server, along with a ‘force’ parameter. If the parameter is ‘false’ a reply is sent indicating if the active honors the request. If the parameter is ‘true’ the active server must shutdown immediately knowing that the standby server will takeover anyway regardless. Unlike the JOIN and STATE messages, the TAKEOVER message can be sent directly between FMS clients. This message can be used, for example, to initiate a pre-emptive takeover of a server which is in an active state. If the takeover is forced, the standby server will reboot the active server's node if it does not receive notification that the active server has changed its state to an inactive state within a predetermined period of time.

As described above, the FMS manages cooperative and preemptive failover of servers from one server to another server within the same server group. FMS may be implemented in two layers: FMS API and FMS SYS. The FMS API provides APIs to create, delete, and manage the four FMS object types: nodes, servers, server groups, and monitors. This layer also implements a finite state machine that manages server state changes. The second FMS layer, FMS SYS, manages node states, implements the FMS synch server including initialization algorithms and voting algorithms, and communicates state changes among nodes.

The FMS layers use a number of other sub-processes. FMS API uses shared execution engines (SEE) and execution engines (EE) to call monitor callback routines, and uses the object management system (OMS 230) to implement its four object types. FMS SYS uses the heart beat management system (HMS 210) to communicate between nodes, and to periodically check the health of nodes. HMS 210, in turn, uses the messaging system (MS 220) to communicate between nodes.

As indicated above, the HMS 210 provide inter-node state monitoring. In the preferred embodiment of the present invention, through the HMS 210, a node actively reports its liveness and state change information to the active FMS synch server node (if it is an FMS client or the standby FMS synch server) or to all FMS client nodes and the standby FMS synch server node (if it is the active FMS synch server node). At the same time, the FMS client nodes and the standby FMS synch server node monitor the active FMS synch server node's heartbeats, and the active FMS synch server node monitors all FMS clients nodes' heartbeating and the standby FMS synch server node's heartbeating. Preferably, FMS client nodes do not heartbeat each other directly. Instead, they use the active FMS synch server as conduit to get notification of node failures and state changes. This effectively decreases heartbeat bandwidth consumption. Preferably, failure of the active FMS sync server node will cause the FMS clients to locate a new active FMS synch server (formerly the standby FMS synch server), to execute the JOIN process described above, and, once joined, to update the states of the remote nodes, servers, and server groups with the state information received from the new active FMS synch server.

It should be appreciated, however, that in alternative embodiments of the present invention, each FMS can be configured to directly communicate its state changes to some or all of the other FMSs without using an FMS synch server as a conduit. In such an embodiment, the FMS synch server might be eliminated entirely from the system.

Preferably, the HMS supports two patterns of heartbeating: heartbeat reporting and heartbeat polling. Both types of heartbeating can be supported simultaneously in different heartbeating instances. In certain preferred embodiments of the present invention, the system user can decide which one to use. With heartbeat reporting, a node actively sends heartbeat messages to a remote party without the remote party explicitly requesting it. This one way heartbeat is efficient and more scalable in environments where one way monitoring is deployed. Two nodes that are mutually interested in each other can also use this mechanism to report heartbeat to each other by exchanging heartbeats (mutual heartbeat reporting). The alternative is a polling mode where one node, server, or server group (e.g., a standby server) requests a heartbeat from another node, server, or server group (e.g., the active server), which responds with the heartbeat reply only upon request. This type of heartbeating can be adaptive and saves bandwidth when no one is monitoring a node, server, or server group. In the embodiments described above, a mutual heartbeat reporting system is implemented, wherein each FMS client (and the standby FMS synch server) heartbeats the active FMS synch server. As explained above, the FMS synch server responds to each heartbeat received from a remote FMS, with a responsive heartbeat indicating the state of each node, server, and server group in the system.

As indicated above, a lack of heartbeat reporting for a predetermined period of time or the lack of a reply to polling over a predetermined period of time should result in the state of corresponding node, server, or server group being changed to unknown on each FMS which is monitoring the heartbeat.

It is important to note the difference between HMS heartbeats and ping-like heartbeating. Unlike ping-type heartbeats, the HMS includes state change information in the heartbeat response which may be indicative of the liveness of the node, server, or server group generating the heartbeat. For example, an HMS heartbeat will generate notification when an node or server being monitored has state change from active to offline. In such a case, even though the node was responsive to the heartbeat (i.e., ping-like heartbeating), the indication of an offline state indicates that the node is not properly operational. It should be noted, that if no response to a heartbeat is received over a predetermined period of time, this heartbeat silence will be interpreted as a “state change” to the unknown state.

The HMS can also support piggybacking data exchange. In this regard, a local application may collect interested local data and inject it into heartbeat system, specifying which remote node, server, or application it intends to send the data to. HMS will pick up the data and send it along with a heartbeat message that is destined for the same remote node, server or application. On the receiving end, the application data is extracted and buffered for receipt by the destination application. With heartbeat polling or mutual reporting heartbeating, FMS or any other application can use this piggyback feature (perhaps, with less frequency than basic heartbeating) to exchange detailed system information and/or to pass commands and results. As an example, a heartbeat message may include a “piggy back data field”, and, through the use of this field, an application can request a remote server to perform a specified operation, and to return the results of the operation to the application via a “piggy back data field” in a subsequent heartbeat message. The application can then verify the correctness of the response to determine whether the remote server is operating correctly. With ping-type heartbeating, it is only possible to determine whether the target (e.g., a server) is sufficiently operational to generate a responsive “ping”.

The messaging system (MS 220) is preferably a connection-oriented packet-based message protocol implementation. It provides delivery of messages between network nodes, and allows for any medium to be used to carry MS traffic by the provision of an adapter layer (i.e., a software entity on the node that is dedicated to driving traffic over a specific medium (e.g., point to point serial connection, shared memory, ethernet)). In this regard, a message is a block of data to be transferred from one node to another, and a medium is a communication mechanism, usually based on some physical technology such as ethernet, serial line, or shared-memory, over which messages can be conveyed. The communication mechanism may provide a single node-to-node mechanism, e.g. serial line, or may link many nodes, e.g. ethernet. In any event, the medium provides the mechanism to address messages to individual nodes. While the above referenced MS 220 is particularly flexible and advantageous, it should be appreciated that any alternative MS 200 capable of supporting the transmission of state changes in the manner described above can also be used.

In accordance with further embodiments of the present invention, active/active sparing can be provided in server groups in order to allow server load sharing. In accordance with this embodiment, two or more servers within a server group could be active at the same time in order to reduce the load on the individual servers. Standby servers may, or may not, be provided in such an embodiment.

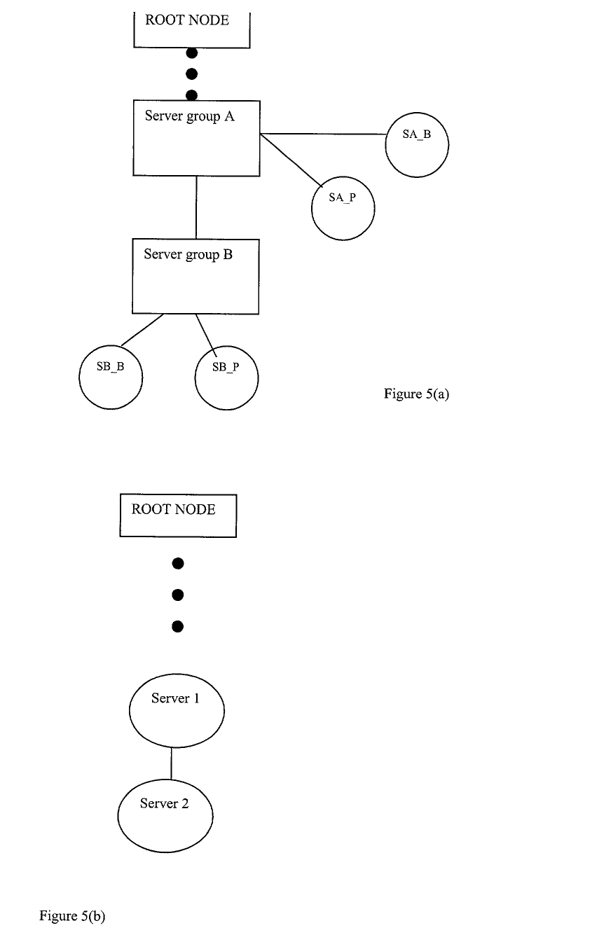

In accordance with other embodiments, hierarchical servers and/or server groups can be provided, with the state of a server propagating upwards and downwards in accordance with customizable state propagation filters. For example, if a first server group is providing a load balancing service for a second server group, the first and second server groups may be arranged in a hierarchical configuration as shown in FIG. 5(a) such that, when the FMS synch server determines that the second server group (group B) is offline because, for example servers SB_B and SB_A have failed, it will set the states of the first server group (Group A), and servers SA_P and SA_B to offline as well. Similarly, individual servers can be arranged in hierarchical groups. For example, referring to FIG. 5(b), if server 1 requires the services of server 2, these servers can be arranged in a hierarchical relationship such that, when server 2 becomes inactive (e.g., offline, failed, etc), the FMS synch server will change the state of server 1 to an inactive state (e.g., offline) as well. Moreover, as illustrated in FIGS. 5(a,b), the hierarchical relationship between server groups and/or servers can be represented in the OMS tree. User configurable “propagation filters” can be used to control the direction, and extent, of state propagation. For example, in the illustration of FIG. 5(a), it may or may not be desirable to automatically set the state of the second server group (and its servers SB_B and SB_A) to offline when the first server group goes offline.

In the preceding specification, the invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A system comprising:
a plurality of nodes, each node having a processor executable thereon;
a first server group, the first server group including a first server capable of performing a first service and a second server capable of performing the first service, the first server being in one of a plurality of states including an active state and a standby state, the second server being in one of the active state and an inactive state, the first server being executable on a first node of the plurality of nodes and the second server being executable on a second node of the plurality of nodes;
a second server group, the second server group including a third server capable of performing a second service and a fourth server capable of performing the second service, the third server being in one of the plurality of states including the active state and the standby state, the fourth server being in one of the active state and an inactive state, the third server being executable on the first node, the fourth server being executable on one of the plurality of nodes other than the first node;
a failover management system, the failover management system, upon determining that a failure has occurred on the first node, instructing the second server to change its state to the active state if the first server was in the active state when the failure determination occurred, and instructing the fourth server to change its state to the active state if the third server was in the active state when the failure determination occurred.

2. The system of claim 1, wherein the failover management system includes a failover management process executing on each of the first node, the second node, and one of the plurality of nodes other than the first node.

3. The system of claim 2, wherein the failover management process on the first node includes information indicative of a current one of the plurality of states for the first server, the second server, the third server, and the fourth server.

4. The system of claim 3, wherein the failover management process on the first node is operable to notify the failover processes on the second node and on the one of the plurality of nodes other than the first node of the current state of the first server and the third server.

5. The system of claim 1, wherein the plurality of states include the active state, the standby state, an initializing state, a failed state, and an offline state.

6. The system of claim 5, wherein the plurality of states include an unknown state.

7. The system of claim 1, further comprising a fifth server on one of the plurality of nodes, the fifth server not forming a part of any failover server group, the fifth server being operable to request the first service from the first server, and wherein the failover management system notifies the fifth server of changes in the state of the first server.

8. The system of claim 7, wherein the fifth server is notified of changes in the state of the first server via a monitor executing on the one of the plurality of nodes.

9. The system of claim 1, further comprising a heartbeat management system on each of the first node, second node, and the one of the plurality of nodes other than the first node, each heartbeat management system periodically transmitting a message to a common one of the plurality of nodes.

10. The system of claim 9, wherein the heartbeat message includes a current state of the node on which the heartbeat management system transmitting the heartbeat message resides.

11. The system of claim 10, wherein the common one of the plurality of nodes has a global failover controller executing thereon.

12. The system of claim 11, wherein the common one of the plurality of nodes is one of the first node, the second node, and the one of the plurality of nodes other than the first node.

13. The system of claim 10, wherein the common one of the plurality of nodes is a third node, and wherein the third node has a global failover controller executing thereon, and the first node, the second node, and the one of the plurality of nodes other than the first node each have a respective local failover controller executing thereon.

14. The system of claim 1, further comprising a heartbeat management system on each of the first node, second node, and the one of the plurality of nodes other than the first node, each heartbeat management system, in response to a heartbeat message received from a heartbeat management system on another node in the system, transmits a heartbeat message to said node in the system.

15. The system of claim 14, wherein the heartbeat message includes a current state of the node on which the heartbeat management system transmitting the message resides.

16. The system of claim 1, further comprising a monitor on at least one of the nodes, the monitor having associated therewith a software entity and a target, the target being one of the first server, the second server, the third server, the fourth server, the first server group, and the second server group, and wherein the monitor notifies the software entity of status changes in the target.

17. A failover management process executable on a node that includes a first server in a first server group and a second server in a second server group, the failover management process comprising the steps of:
determining a current state of the first server and a current state of the second server, the current state of each server being one of a plurality of states including an active state, a standby state, and a failed state;
monitoring a current state of a third server on a remote node, the third server being one of the servers in the first server group, the current state of the third server being one of the plurality of states including the active state, the standby state, and the failed state;
monitoring a current state of a fourth server on a remote node, the fourth server being one of the servers in the second server group, the current state of the fourth server being one of the plurality of states including the active state, the standby state, and the failed state;
notifying a process on the remote node executing the third server and a process on the remote node executing the fourth server of changes in the current state of the first server and the second server;
if the current status of the first server is the standby state, and the current state of the third server is the failed state, changing the current state of the first server to the active state;
if the current state of the second server is the standby state, and the current state of the fourth server is the failed state, changing the current state of the second server to the active state.

18. The failover management process of claim 17, wherein the step of monitoring the third server comprises receiving a heartbeat message, the heartbeat message including information indicative of the status of the third server.

19. The failover management process of claim 18, wherein the step of monitoring the fourth server comprises receiving a heartbeat message, the heartbeat message including information indicative of the current state of the fourth server.

20. The failover management process of claim 19, wherein the heart beat messages is transmitted by a global failover controller, and wherein the global failover controller receives information indicative of the current state of the fourth server from the remote node executing the fourth server and wherein the global failover controller receives information indicative of the current state of the third server from the remote node executing the third server.

21. The failover management process of claim 20, wherein the notifying step further comprises transmitting state changes to the first and second servers to the global failover controller, and wherein the global failover controller notifies the process on the remote node executing the third server and the process on the remote node executing the fourth server of changes in the current state of the first server and the second server

22. A system comprising:
a plurality of nodes, each node having a processor executable thereon;
a first server group, the first server group including a first server capable of performing a first service and a second server capable of performing the first service, the first server being in one of a plurality of states including an active state and a standby state, the second server being in one of the active state and an inactive state, the first server being executable on a first node of the plurality of nodes and the second server being executable on a second node of the plurality of nodes;
a second server group, the second server group including a third server capable of performing a second service and a fourth server capable of performing the second service, the third server being in one of the plurality of states including the active state and the standby state, the fourth server being in one of the active state and an inactive state, the third server being executable on the first node, the fourth server being executable on a third node of the plurality of nodes;
a failover management system, the failover management system, upon determining that a failure has occurred on the first server but not on the third server, instructing the second server to change its state to the active state if the first server was in the active state when the failure determination occurred, the fourth server remaining in a standby state if the third server was in the active state when the failure determination occurred.

23. A failover management system, comprising:
a global failover controller executable on a first node of a plurality of nodes;
a first server group, the first server group including a first server capable of performing a first service and a second server capable of performing the first service, the first server being in one of a plurality of states including an active state and a standby state, the second server being in one of the active state and an inactive state, the first server being executable on a second node of the plurality of nodes and the second server being executable on a third node of the plurality of nodes;
a second server group, the second server group including a third server capable of performing a second service and a fourth server capable of performing the second service, the third server being in one of the plurality of states including the active state and the standby state, the fourth server being in one of the active state and an inactive state, the third server being executable on the first node, the fourth server being executable on a node other than the second node and the third node of the plurality of nodes;
a first local failover controller executable on the second node, and a second local failover controller executable on the third node, the first local failover controller notifying the global failover controller of a current state of the first server and the third server, the second local failover controller notifying the global failover controller of a current state of the second server;
the global failover controller notifying the first local failover controller of the current state of the second server and the fourth server and notifying the second failover controller of a current state of the first server;
the first local failover controller, upon receiving notification that the second server is in an inactive state, instructing the first server to change its state to the active state if the first server was in an inactive state when the notification was received,
the second local failover controller, upon receiving notification that the first server is in an inactive state, instructing the second server to change its state to the active state if the second server was in an inactive state when the notification was received,
the first local failover controller, upon receiving notification that the fourth server is in an inactive state, instructing the third server to change its state to the active state if the fourth server was in an inactive state when the notification was received.

24. The system of claim 23, wherein the node other than the second node and the third node of the plurality of nodes is a fourth node, and wherein the fourth node has a third local failover controller executable thereon, the third local failover controller notifying the global failover controller of a current state of the fourth server.

25. The system of claim 23, wherein the node other than the second node and the third node of the plurality of nodes is the first node.

26. The failover management process of claim 17, wherein the remote node executing the third server is a first node.

27. The failover management process of claim 26, wherein the remote node executing the fourth server is a second node.

28. The failover management process of claim 26, wherein the remote node executing the fourth server is the first node.

29. The system of claim 1, wherein the inactive state is one of the standby state, a failed state, and an offline state.

30. The system of claim 2, wherein the first node can be in one of a plurality states including the active state and an inactive state, the second node can be in one of a plurality states including the active state and an inactive state, and the node other than the first node can be in one of a plurality states including the active state and an inactive state.

31. The system of claim 31, wherein the failover management process on the first node includes information indicative of a current one of the plurality of states for the first server, the second server, the third server, the fourth server, the first node, the second node, and the node other than the first node.

32. The system of claim 31 wherein the failover management process on the first node is operable to notify the failover processes on the second node and on the one of the plurality of nodes other than the first node of the current state of the first server, the third server, and the first node.

33. The system of claim 1, further comprising an application on one of the plurality of nodes, the application being operable to request the first service from the first server, and wherein the failover management system notifies the application of changes in the state of the first server.

34. The system of claim 1, further comprising a monitor on at least one of the nodes, the monitor having associated therewith a software entity and a target, the target being one of the first server, the second server, the third server, the fourth server, the first server group, and the second server group, the first node, the second node, and the node other than the first node, and wherein the monitor notifies the software entity of status changes in the target.

35. A computer readable medium, having stored thereon, computer executable process steps that are executable on a node that includes a first server in a first server group and a second server in a second server group, the computer executable process steps comprising:
determining a current state of the first server and a current state of the second server, the current state of each server being one of a plurality of states including an active state, a standby state, and a failed state;
monitoring a current state of a third server on a remote node, the third server being one of the servers in the first server group, the current state of the third server being one of the plurality of states including the active state, the standby state, and the failed state;
monitoring a current state of a fourth server on a remote node, the fourth server being one of the servers in the second server group, the current state of the fourth server being one of the plurality of states including the active state, the standby state, and the failed state;
notifying a process on the remote node executing the third server and a process on the remote node executing the fourth server of changes in the current state of the first server and the second server;
if the current status of the first server is the standby state, and the current state of the third server is the failed state, changing the current state of the first server to the active state;
if the current state of the second server is the standby state, and the current state of the fourth server is the failed state, changing the current state of the second server to the active state.

36. The computer readable medium of claim 35, wherein the step of monitoring the third server comprises receiving a heartbeat message, the heartbeat message including information indicative of the status of the third server.

37. The computer readable medium of claim 36, wherein the step of monitoring the fourth server comprises receiving a heartbeat message, the heartbeat message including information indicative of the current state of the fourth server.

38. The computer readable medium of claim 37, wherein the heart beat messages is transmitted by a global failover controller, and wherein the global failover controller receives information indicative of the current state of the fourth server from the remote node executing the fourth server and wherein the global failover controller receives information indicative of the current state of the third server from the remote node executing the third server.

39. The computer readable medium of claim 38, wherein the notifying step further comprises transmitting state changes to the first and second servers to the global failover controller, and wherein the global failover controller notifies the process on the remote node executing the third server and the process on the remote node executing the fourth server of changes in the current state of the first server and the second server.

40. A system comprising:
a plurality of nodes, each node having a processor executable thereon;
a first server group, the first server group including a first server capable of performing a first service and a second server capable of performing the first service, the first server being in one of a plurality of states including an active state, a standby state, an offline state, an initialized state and a failed state, the second server being in one of the active state, the standby state, the offline state, the initialized state, and the failed state, the first server being executable on a first node of the plurality of nodes and the second server being executable on a second node of the plurality of nodes;
a second server group, the second server group including a third server capable of performing a second service and a fourth server capable of performing the second service, the third server being in one of the plurality of states including the active state, the standby state, the offline state, the initialized state and the failed state, the fourth server being in one of the active state and the standby state, the failed state, the initialized state and the offline state, the third server being executable on the first node, the fourth server being executable on one of the plurality of nodes other than the first node;
a failover management system, the failover management system, upon determining that a failure has occurred on the first node, instructing the second server to change its state to the active state if the first server was in the active state when the failure determination occurred and if the second server was not in one of the failed state, the initialized state, and the offline state, and instructing the fourth server to change its state to the active state if the third server was in the active state when the failure determination occurred, and if the fourth server was not in one of the failed state, the initialized state, and the offline state
